(19) United States
(12) Patent Application Publication
(10) Pub. No.: US 2007/0129113 A1
(43) Pub. Date: Jun. 7, 2007

(54) Cell phone alerting system

(76) Inventors: Michael Edward Klicpera, La Jolla, CA (US); Ross Tsukashima, San Diego, CA (US); Andy Lakey, Tamecula, CA (US)

Correspondence Address: MICHAEL E. KLICPERA, PO BOX 573, LA JOLLA, CA, 92038-0573, US

(21) Appl. No.: 11/293,658

(22) Filed: Dec. 1, 2005

(51) Int. Cl. H04B 1/38

(52) U.S. Cl. 455/567

(57) ABSTRACT

Disclosed herein is an alerting/warning apparatus and method associated with a particular cell telephone alerts an individual when said owner of the cell phone is separated by a defined distance from their cell phone. Cell phones are becoming smaller and hence, are being lost more often. The solution to this problem which is a portion of the present invention is to make a pendant or other device that the user carries that triggers an alarm if the distance between the pendant and a cell phone becomes too great. The alerting/warning apparatus consists of a visual and/or auditory means located within the alert device that communicates wirelessly with the particular individual's cell phone, including a transmitting and receiving means to communicate with the particular cell phone. Typical devices, such as key chains, necklaces, or other forms of jewelry or wallet inserts will be employed to incorporate the alert apparatus for the cell phone owner's convenience. The alerting/warning apparatus also contains a power source that consisting generally as a battery or other (e.g. solar) energy source. The alerting/warning apparatus will have the capability to set the given distance between the individual and the particular cell phone to adapt to the cell phone owner's individual needs. Also the alerting/warning apparatus can be turned off when it is desired that the present invention not be in use. The alerting/warning apparatus is designed to prevent the loss or minimize the theft of cell phones that are temporarily left behind in unprotected public and private or other places. The method comprises first setting the desired distance that the individual wants to be alerted when the individual and the cell phone or laptop computer are separated by that distance. After making the decision and setting the alerting/warning apparatus for that distance, the individual carries the alerting/warning device (which could be represented as a key chain or other convenient device). Now, when, or if, the cell phone is left on a table, counter, car, boat, ground or any other location and the individual having the alerting/warning apparatus moves to a position that is greater than the distance set on the alerting/warning apparatus, a light and/or auditory alarm, depending on the particular embodiment, is turned on to alarm the individual that their cell phone has been left behind.

### FIELD OF THE INVENTION

The field of art to which this invention relates is in cell phone computer technology and associated accessories. More specifically, the present invention relates to an alerting/warning apparatus that enables an individual to be aware that they have become separated by a defined distance from their cell phone or laptop computer.

### BACKGROUND OF THE INVENTION

It has been described in the prior art the necessity to be able to geo-locate a mobile telephone unit within a given service area both for security and for commercial reasons. The Federal Communication Commission (FCC) has mandated that all mobile units should have a built-in location feature, such that mobile units are able to compute and transmit their location (to an accuracy of within 125 m) to a Public Safety Answering Point (PSAP) at least 67% of the time. This would facilitate emergency response to be dispatched to the site since the user may be incapacitated, or not be aware of their precise location. Besides emergency services, commercial applications involving location specific services such as advertising, location specific billing, fleet location monitoring, navigation, etc. are also envisioned in the near future.

The prior art for computing the location of a mobile telephone can be split into two broad categories; handset-based solutions and network-based solutions. Handset-based solutions are implemented such that the handset has the capability, using a Global Positioning System (GPS) or, alternatively, the time of arrival of signals (forward-link base station to mobile signals) from different base stations (at least 2 base stations are needed), the signal to noise ratio (SNR) of the signals, or a combination of GPS and time of arrival techniques, to ascertain its relative location with respect to the known, fixed locations of the Base Stations, and thereby its exact location, which it then can transmit to the network or to the PSAP.

The basic principle of location computation, for a forward-link handset-based solution, is to receive signals from two or more base stations, and use the signal parameters (like SNR or times of arrival) to estimate the location of the handset from each of the base stations. Since the position of the base stations is known, knowledge of the relative position between the two or more fixed locations leads to an estimate of the location of the mobile station.

Network-based solutions generally involve two or more base stations simultaneously ascertaining the location of the mobile phone from which a location query has originated, relative to the base-stations, using the angle of arrival of the signals (a reverse-link mobile-to-base-station signal), the time(s) of arrival of the signals, or the signal-to-noise ratio of the signals actually received. The signal to noise ratios of these signals are compared to the pre-computed signal-to-noise ratios expected for different locations computed using drive test data. Thus, in a network based solution, two or more base stations receive the signal from the mobile station, i.e., on the reverse link, and those signal parameters (SNR, the time of arrival or the angle of arrival) are used by each base station to estimate the relative location of the mobile, and consequently, its actual location.

Given the importance of location determination, many approaches to computing the location of a mobile telephone exist in the patent literature. For example, U.S. Pat. No. 6,275,186, by Seung-Hyun Kong, teaches a solution where a dedicated searcher uses a combination of Signal-to-Interference ratios and times of arrival of the signal from a handset at multiple base stations to estimate its location. Both network- and handset-based solutions that depend on times of arrival and angle of arrival techniques share the problem that, in many environments, the three base stations needed to accurately locate the mobile transmitter are not ‘seen’ by the mobile transmitter because of the near-far problem. This happens because, on the forward link, the interference from a ‘strong’ base station contributes to the interference seen when the receiver is in the process of detecting and processing ‘weaker’ base stations.

In the case of network based solutions, interference from other mobile transmitters often prevents three base stations from being able to receive, detect and process the signal from a single mobile transmitter. This occurs because, in the reverse link between the mobile station and base station, especially for a base station that is not the serving base station for the mobile station in question, or for one that is not in handoff, the signals from the other mobiles sharing the bandwidth and being served by the base station cause interference in that base station's ability to detect and process the signal from the mobile station that needs the location service.

U.S. Pat. No. 6,263,208, by Chang et al., proposes a solution that uses a pre-computed probability map of pilot strengths for a given cellular area, and uses the actual received pilot strengths to estimate the location. They do not specifically address the issue of how a solution may be obtained if an adequate number of pilot signals are not visible to the mobile unit. Thus, there is no teaching of how to solve the problems of angle of arrival, reflections, and the strength of the signals.

U.S. Pat. No. 6,163,696, by Qi Bi and Wen-Yi Kuo, proposes a network based solution where fake handoff messages are used, i.e., the mobile station increases its power until the primary base station and two or more other surrounding base stations are able to receive its signal. This solution, however, will cause increased interference to the signals from the other served mobiles in the area for the base stations in question. Thus, this solution compounds a strong signal problem.

U.S. Pat. No. 5,812,086 to Bertiger et al. proposes a central transceiver and a re-transmitter in order to service users within buildings. Such a system would be very costly and would not permit a user to use a communication device for geo-location purposes in a building that was not fitted with such a system.

So, while there are several ways to geo-locate a cell phone, there currently is no technology for the owner of a communication device such as a cell phone to ensure that it has not been misplaced, lost, stolen or left behind. Cell phones are being fitted with additional capabilities, such as address and phone number databases, cameras, pictures, e-mail messaging, internet browsing etc. When an owner of a cell phone or laptop computer loses or misplaces his/her cell phone or computer, the owner loses this valuable device and its associated proprietary information and, in the case of cell phones, may be subjected to certain phone charges incurred by use of others who used the cell phone that become lost or stolen.

Furthermore, cell phones are evolving into complex apparatus that store certain confidential information, telephone numbers and photographic images (pictures). The loss of a communication device such as a cell phone not only deprives the owner of this information, but also provides an opportunity for disclosure of this information to an unknown and possibly undesirable individual(s) or corporate entities.

### SUMMARY OF THE INVENTION

Disclosed herein is an personal alerting/warning apparatus and method associated with a particular cell telephone alerts an individual or owner when said individual or owner of the cell phone is separated by a defined distance from their communication device such as a cell phone. Cell phones are becoming smaller and hence, are being lost more often. The solution to this problem which is a portion of the present invention is to make a pendant or other device that the user carries that triggers an alarm if the distance between the pendant and a cell phone becomes too great.

The alerting/warning apparatus consists of a visual and/or auditory means located within the alert device/accessory that communicates wirelessly with the particular individual's cell phone, including a transmitting and receiving means to communicate with the particular cell phone. Typical devices, such as key chains, necklaces, watches or other forms of jewelry or wallet inserts will be employed to incorporate the alerting/warning apparatus for the cell phone owner's convenience. The alerting/warning apparatus also contains a power source that consisting generally as a battery or other (e.g. solar) energy source. The alerting/warning apparatus can also have the capability to set the given distance between the individual and the particular cell phone to adapt to the cell phone owner's individual needs. Also the alerting/warning apparatus can be turned off when it is desired that the present invention not be in use and thus save any associated power requirements. The alerting/warning apparatus is designed to prevent the loss or minimize the theft of cell phones that are temporarily left behind in unprotected public and private or other places. The method comprises first setting the desired distance that the individual wants to be alerted when the individual and the communication device or cell phone are separated by that distance. After making the decision and setting the alerting/warning apparatus for that distance, the individual carries the alerting/warning device (which could be represented as a key chain, watch, pendant, wallet card or other convenient device). Now, when, or if, the cell phone is left on a table, counter, car, boat, airplane, ground or any other location and the individual having the alerting/warning apparatus moves to a position that is greater than the distance set on the alerting/warning apparatus, a light and/or auditory alarm, depending on the particular embodiment, is turned on to alarm the individual that their cell phone has been left behind. Furthermore, a communication device such as a cell phone that incorporates GPS technology can include the means to communicate the geo-location and GPS coordinates of the communication device or cell phone to the accessory for observation by the owner.

### BRIEF DESCRIPTION OF THE DRAWINGS

The invention can be better understood by reference to the following description, taken in connection with the accompanying drawings.

FIG. 1 is a perspective view of an altering/warning apparatus warning the owner of a cell/mobile phone that his/her cell phone is a given distance away.

FIG. 2 is a block diagram describing the typical phone call processing states used in cell phone communication.

FIG. 3 is a block diagram illustrating the mobile phone listening for a pendant/keyfob during the idle state of the mobile call processing state diagram.

FIG. 4 is a block diagram illustrating the mobile phone transmitting a signal to a pendant/keyfob during the idle state of the mobile call processing state diagram.

FIG. 5 is a block diagram illustrating bidirectional communication between a pendant/keyfob during the idle state of the mobile call processing state diagram.

FIG. 6 is an electrical schematic of the general components and circuitry used for a receiving/transmitting means and the visual/auditory/vibratory means of the alerting/warning apparatus.

### DESCRIPTION OF THE PREFERRED EMBODIMENT

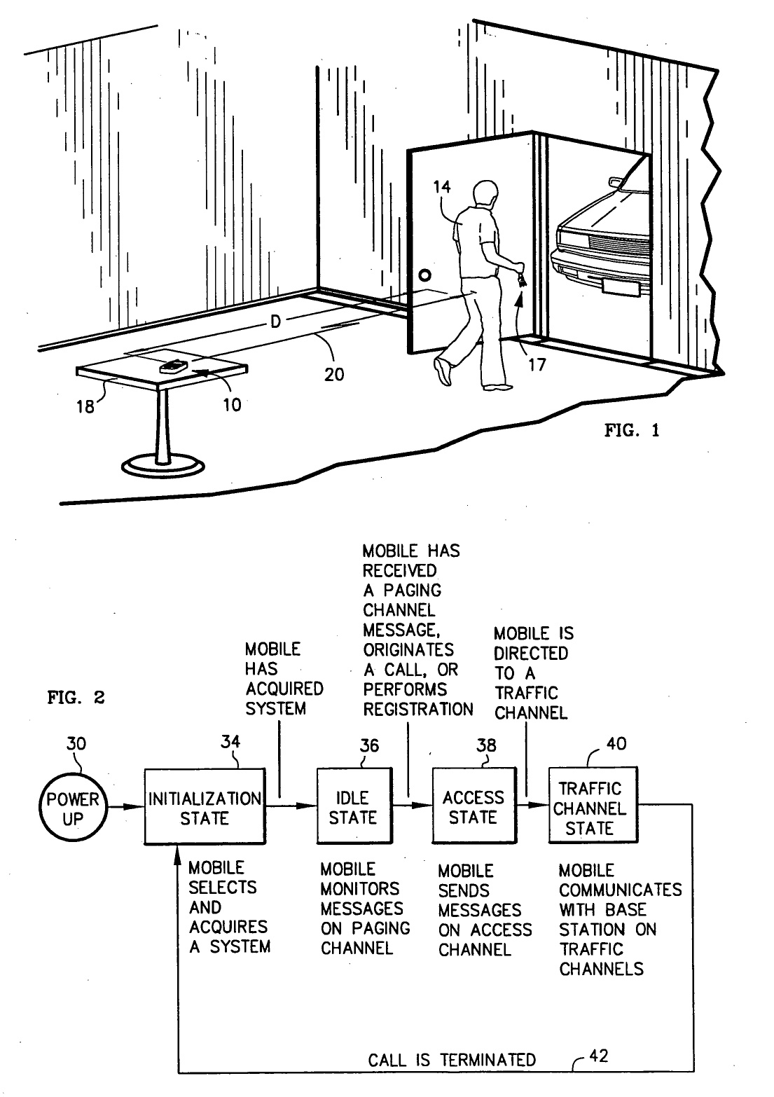

The present invention pertains to an alerting/warning apparatus and method associated with a specifically designed cell telephone that alerts an individual when said owner of the cell phone is separated by a defined distance from their cell phone. The solution to this problem which is a portion of the present invention is to make a key chain, pendant or other accessory that the user has in their possession which triggers an alarm if the distance between the key chain, pendant or other accessory and a cell phone exceeds a specified limit. In this regard, the present invention comprises two individual components; 1) a specifically designed key chain, pendant, card apparatus or other accessory alerting/warning device, and 2) a specifically designed or programmed cell phone. Referring to FIG. 1, the alerting/warning apparatus may consists visual, auditory and/or vibratory means located within the warning/alerting apparatus 17 (or may consist of a visual, auditory, and or vibratory means located within the cell phone 10, depending on the particular embodiment) that communicates wirelessly 20, using RF or optical technology, with the particular individual's cell phone 10, including a transmitting and/or receiving means to communicate with the particular cell phone. Typical devices, such as key chains 17, necklaces, or other forms of jewelry or wallet inserts will be employed to incorporate the appropriate components and circuitry for the alerting/warning apparatus 17 for the cell phone owner's convenience. The alerting/warning apparatus 17 also contains a power source that consisting generally as a battery or other (e.g. solar) energy source. The alerting/warning apparatus 17 or the cell phone 10 will have the capability to set the given distance 12 between the individual 14 and the particular cell phone 10 to adapt to the cell phone owner's individual needs. Also the alerting/warning apparatus 17 can be turned off when it is desired that the present invention not be in use. The alerting/warning apparatus 17 is designed to prevent the loss or minimize the theft of cell phones 10 that are temporarily left behind in unprotected public and private or other places. The method comprises first setting the desired distance that the individual wants to be alerted when the individual and the cell phone are separated by that distance. After making the decision and setting the alerting/warning apparatus 17 or cell phone 10 for that distance, the individual carries the alerting/warning device (which is represented as a key chain 17 in FIG. 1 may also be a pendant, card apparatus or other accessory). Now, when, or if, the cell phone is left on a table or counter 18, car, boat, ground or any other location and the individual having the alerting/warning apparatus moves to a position that is greater than the distance 12 set on the alerting/warning apparatus, a visual light source, auditory alarm and/or vibratory means, depending on the particular embodiment, is turned on to alert the individual that their cell phone has been left behind. In addition, the cell phone can be modified to have the ability to alert the user utilizing the visual, auditory or vibration means described herein.

In order to disclose the method for the present invention, a brief discussion, as shown generally in FIG. 2, of an example of certain cell phone technology is presented. In this example, the call processing sequence and signal strength analysis used in CMDA cell phones will be presented and explained. It is contemplated by the Applicants that other cell phone technology, e.g. GSM, can also be utilized to accomplish the methods and designs of the present invention.

There are five embodiments or workable combinations of alarms matched with transmitters/receivers or transceivers that have been evaluated as potential means to accomplish the methods and apparatus of the present invention.

During Normal Operation, the Cell Phone can be in any one of the Following States:

Cell phone initialization
Phone idle
System access
Cell phone control on the traffic channel

After power up 30, the cell phone enters the initialization state 34. This state contains four sub-states. They are: System determination, pilot channel acquisition, sync channel acquisition and timing change. Upon completion of these four sub-states the cell phone is fully capable of communication with a base station and can thus register with the cellular network (selected during the system determination sub-state) of its location.

During the idle phase 36, cell phone monitors the forward link base station paging channel for messages such as an incoming call. It also periodically monitors neighboring base station signal strengths in preparation for transit to other cell zones. If the cell phone receives a message or the user initiates a call or message the phone transitions out of idle phase and moves to the access state 38.

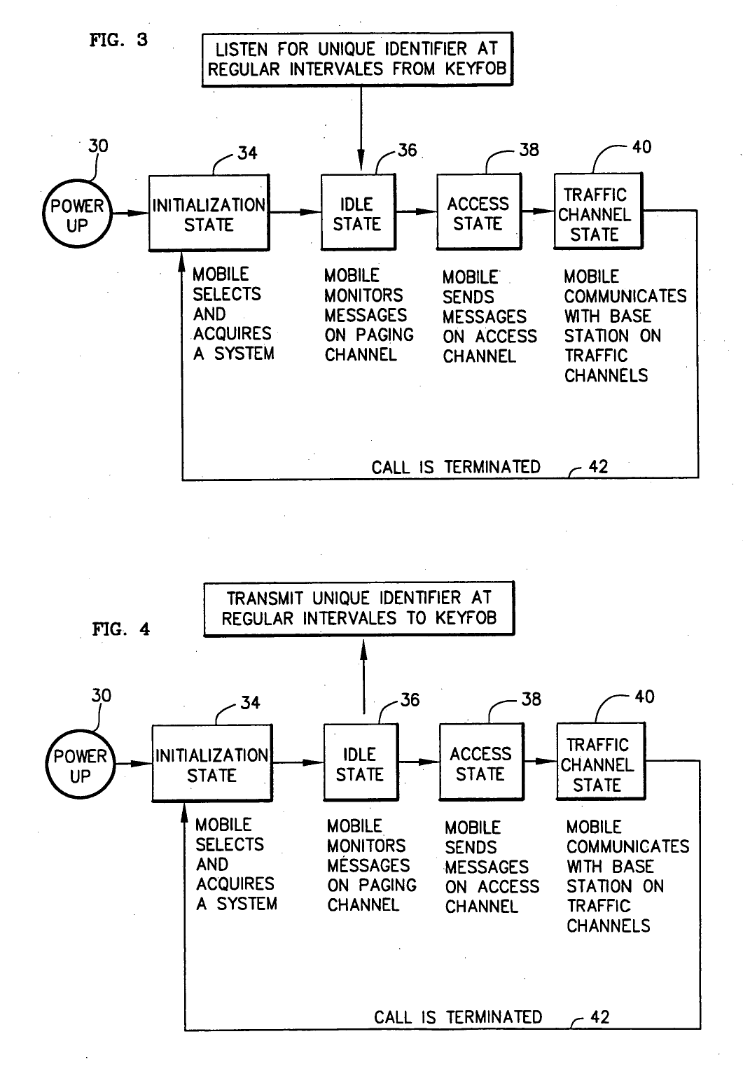

FIG. 3 refers to the processing states for the 1^{st} embodiment of the present invention. On power up 30, the present invention cell phone 10 goes through an initialization step 34 and then resides in an idle state 36. The processing states continue with an access state 38 and then to the traffic channel state when a call is made 40, or a call is received. Upon termination of the call 42, the cell phone returns to the initialization state 34, and then back to monitoring paging channel messages in the idle state 36. When the cell phone 10 is in the idle state 36, the cell phone listens for a signal transmitted 20 from the key chain, pendant, card apparatus, or other accessory 17 and alarms if it loses track of this signal from the key chain, pendant, card apparatus or other accessory 17. The advantage of this embodiment is that only one-way communication is needed. Most cell phones already incorporate technology circuits that can evaluated signal strength, so this technology could be implemented by making improvements with software modifications to provide one of the communication measurements. The participant 14 would generally have a key chain, pendant, card apparatus or other accessory 17 that utilizes a unique identifier that the cell phone 10 is programmed to listen for. In this embodiment, the pendant key chain, pendant, card or other accessory 17 will include transmitter circuitry to communicate with the present invention cell phone 10. This embodiment utilizes a design that saves cell phone battery life and can be manufactured in relatively smaller physical sizes due to the simplified circuitry. In operation, the user 14 would turn on the key chain, pendant, card apparatus or other accessory 17 which would first send a message to and establish communication with the cell phone 10, telling it to begin monitoring the key chain, pendant signal, card apparatus or other accessory's 17 signal strength. If it determined that the signal is too low (and the distance too far away), the cell phone 10 would alarm either by illuminating a visual means, generating an auditory signal and/or initiating a vibratory means.

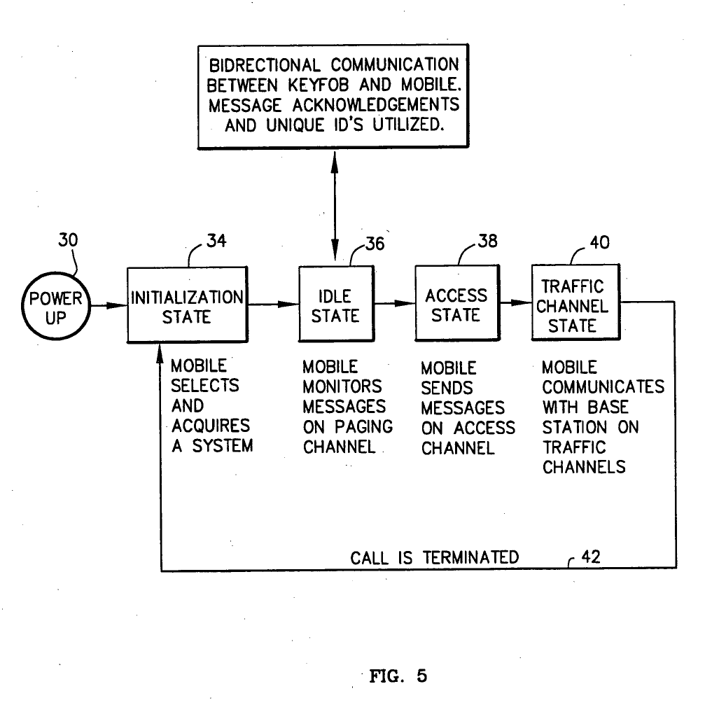

FIG. 4 refers to the processing states for the 2^{nd} embodiment of the present invention. On power 30 up the present invention cell phone 10 goes through an initialization step 34 and then resides in an idle state 36. The processing states continue with an access state 38 and then to the traffic channel state when a call is made 40, or a call is received. Upon termination of the call 42, the cell phone returns to the initialization state 34, and then back to monitoring paging channel messages in the idle state 36. In this design, the cell phone 10 at periodic intervals sends out a unique identifier to the keyfob 17, which alarms if it loses track of this signal and additionally, geo-location information could be sent from the cell 10 to a display in the keyfob 17. The advantage of this embodiment is that only one-way communication is needed. Currently manufactured cell phones already incorporate technology circuits that can send out unique signals, so this technology could be implemented with improved software modifications to provide one of the communication measurements. The participant 14 would generally wear or have in their possession a key chain, pendant, card apparatus or other accessory 17 that listens for a unique identifier that the cell phone 10 is programmed to broadcast. The key chain, pendant, card apparatus or other accessory 17 will include the circuitry required to allow it to receive broadcast information from the cell phone 10. The key chain, pendant, card apparatus or other accessory 17 will also include the circuitry required to allow it to generate a visual, auditory and/or vibratory alarm. This saves design also saves the cell phone's 10 battery life and can be manufactured in relatively smaller physical sizes due to the simplified circuitry. In this design, the user would turn on the present invention key chain, pendant, card apparatus or other accessory 17 which would first listen for communication signals from the cell phone and then calculate relative distance. If during use, it determined that the distance was too far, the present invention key chain, pendant, card apparatus or other accessory 17 would alarm either by illuminating a visual means or generating an auditory signal. It is also anticipated by the Applicants that a communication device such as a cell phone 10 that incorporates GPS technology can include the means to communicate the geo-location and GPS coordinates of the communication device or cell phone 10 to the present invention key chain, pendant, card apparatus or other accessory 17 for observation by the owner 14.

FIG. 5 refers to the processing states for the 3^{rd}, 4^{th} and 5^{th} embodiments of the present invention. On power 30 up the present invention cell phone 10 goes through an initialization step 34 and then resides in an idle state 36. The processing states continue with an access state 38 and then to the traffic channel state when a call is made 40, or a call is received. Upon termination of the call 42, the cell phone returns to the initialization state 34, and then back to monitoring paging channel messages in the idle state 36. When the cell phone 10 is in the idle state 36, two-way communication is established between the cell phone 10 and the key chain, pendant, card apparatus or other accessory.

In the 3^{rd} embodiment, a bi-directional communication link is established between the cell phone 10 and the accessory 17, and the cell phone 10 alarms, by visual, auditory and/or vibratory means, if it doesn't get a response back from the key chain, pendant card apparatus or other accessory 17. The advantage of this embodiment is that two-way communication between the cell phone's 10 keyfob and the mobile key chain, pendant, card apparatus or other accessory 17 which would result in reducing the occurrence of false alarms and increased reliability. Currently manufactured cell phones already incorporate this technology to transmit unique identifiers, so this technology could be improved with software modifications to provide one of the communication methods. The participant would generally have a key chain, pendant, card apparatus, or other accessory 17 that utilizes a unique identifier that the cell phone is programmed to listen for. The key chain, pendant, card apparatus or other accessory 17 will include transmitter and receiver circuitry to communicate with the cell phone 10. This design requires power from the cell phone and probably will reduce battery life. Furthermore, the increased circuitry will result in a relatively larger in physical sizes for both the cell phone 10 and accessory 17. In operation, the user would turn on the present invention key chain, pendant, card apparatus or other accessory 17 which would first send a message to and establish communication with the cell phone 10, telling it to begin monitoring the key chain or pendant signal strength. If it determined that the distance is too low (and too far away), the cell phone 10 would alarm either by illuminating or generating a visual, auditory and/or vibratory signal. It is also anticipated by the Applicants that a communication device such as a cell phone 10 that incorporates GPS technology can include the means to communicate the geo-location and GPS coordinates of the communication device or cell phone 10 to the present invention key chain, pendant, card apparatus or other accessory 17 for observation by the owner 14.

In the 4^{th} embodiment, a bi-directional communication link is established between the cell phone 10 and the accessory 17, and the key chain, pendant card apparatus or other accessory 17 alarms, by visual, auditory and/or vibratory means, if it doesn't get a response back from the cell phone 10. This bi-directional communication has the advantage that the possibilities for false alarms are reduced, and reliability is increased because the cell phone 10 actually acknowledges and responds to the key chain, pendants, card apparatus or other accessory's 17 transmission. The key chain, pendant, card apparatus or other accessory 17 needs to have a transceiver and a receiver, as well as the alarm circuitry. Relative physical size and battery requirements for the key chain, pendant, card apparatus or other accessory 17 are thereby increased. It is also anticipated by the Applicants that a communication device such as a cell phone 10 that incorporates GPS technology can include the means to communicate the geo-location and GPS coordinates of the communication device or cell phone 10 to the present invention key chain, pendant, card apparatus or other accessory 17 for observation by the owner 14.

In the 5^{th} embodiment, both the cell phone 10 and the key chain, pendant, card apparatus or other accessory 17 alarm once communication between the two is lost. Again, bi-directional communication is required. This embodiment has the advantage that the possibilities for false alarms are reduced because the cell phone actually acknowledges and responds to the key chain or pendants transmission. Additionally, reliability in detecting and alerting the user when a cell phone is being left behind is increased due to the redundancy in the RF or optical signaling scheme and alarms. The key chain, pendant, card apparatus or other accessory 17 needs to have a transceiver and a receiver, as well as the alarm circuitry. It is also anticipated by the Applicants that a communication device such as a cell phone 10 that incorporates GPS technology can include the means to communicate the geo-location and GPS coordinates of the communication device or cell phone 10 to the present invention key chain, pendant, card apparatus or other accessory 17 for observation by the owner 14.

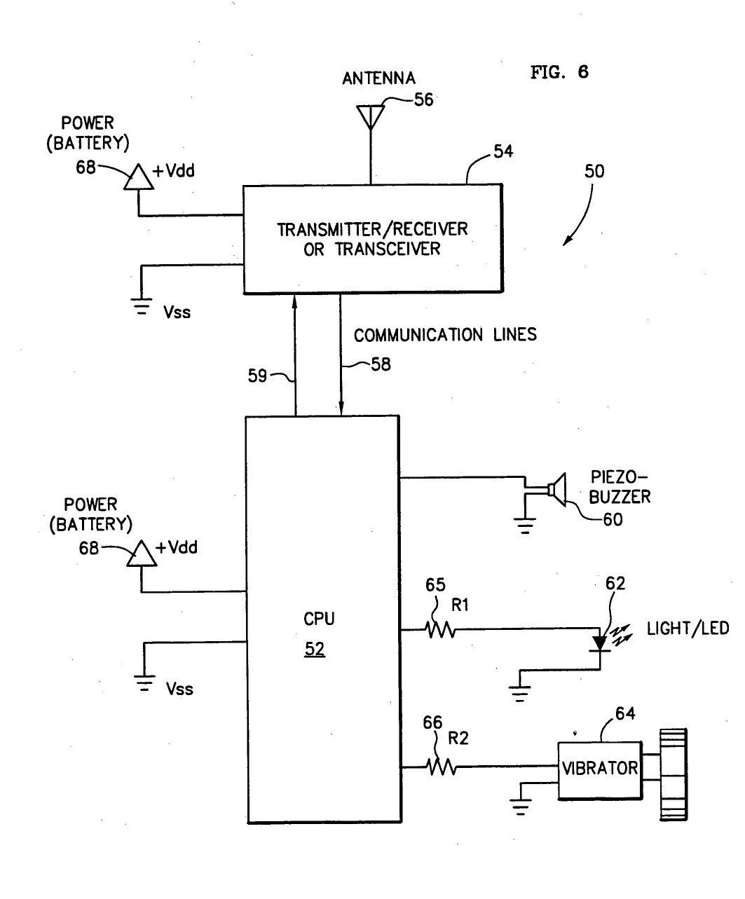

Shown in FIGS. 6 and 7 is a simplified electrical schematic of the general components included in the alerting/warning apparatus 17. The general components provided will need to be modified appropriately for the particular embodiments disclosed and claimed herein (e.g. visual/auditory/vibratory components will not be necessary in the alerting/warning apparatus when the present invention cell phone 10 is designed to provide the visual/auditory/vibratory warning or alerting means, such in 1^{st} and 3^{rd} embodiments disclosed and claimed herein).

In the FIG. 6, the general components and circuitry designed for the key chain, pendant, card apparatus or other accessory which functions as an alerting/warning device 17. In the center is the microprocessor 52 that processes the information supplied by electrical connection means 58 from the transmitter/receiver (transceiver) components 54. An electrical connection means 59 is also provided for processing information and sending signals to the transmitter/receiver (transceiver) components 54. The microprocessor 52 typically includes a timing crystal (not shown) used for clocking operations and is connected to and energized by an appropriate power supply 68. The power supply 68 can be a typical battery, or include solar source components which charge the battery or a capacitor means. Also included in the microprocessor circuitry are an auditory device (piezo-buzzer) 60, an illumination device (light/LED) 62 and/or a vibratory device 64. A resistor 65 is shown electrically connected between the illumination device 62 and the microprocessor 52. Another resistor 66 is shown electrically connected between the vibratory device 64 and the microprocessor 52.

The transmitter/receiver 54 component and circuitry is connected to and energized by an appropriate power supply (e.g. battery) 68. The transmitter/receiver also includes a antenna means 56. The antenna means 56 can communicate 20 with the cell phone 10 using radio frequency (RF), microwave, or optical light technology.

Although the description of the preferred embodiments and methods has been quite specific, it is contemplated that various modifications could be made without deviating from the spirit of the present invention.

1. A system for monitoring and alerting an owner of the cell phone that said cell phone has exceeded a given distance between said owner and said cell phone comprising:
an accessory having a transmitting means which transmits a signal to a cell phone, said accessory associated with said owner;
a cell phone programmed to monitor the strength of said signal sent by said accessory, said cell phone programmed to initiate an alerting means when said accessory is a given distance from said cell phone.

2. The system recited in claim 1, further comprising that said signal includes a unique identifier that said cell phone recognizes.

3. The system recited in claim 1, wherein said accessory is a pendant.

4. The system recited in claim 1, wherein said accessory is a part of a key chain.

5. The system recited in claim 1, wherein said accessory comprises a card design.

6. The system recited in claim 1, where said wireless signal uses radio frequency technology.

7. The system recited in claim 1, wherein said wireless signal uses optical light technology.

8. An system for monitoring and alerting an owner of the cell phone that said cell phone has exceeded a given distance between said owner and said cell phone comprising:
an accessory having a receiving means which monitors a signal from a cell phone, said accessory associated with said owner;
a typical cell phone programmed to transmit said signal sent to said accessory,
said accessory programmed to initiate an alerting means when said accessory is a given distance from said cell phone.

9. The system recited in claim 9, further comprising that said signal includes a unique identifier that said accessory recognizes.

10. The system recited in claim 9, wherein said accessory is a pendant.

11. The system recited in claim 9, wherein said accessory is a part of a key chain.

12. The system recited in claim 9, wherein said accessory comprises a slim card design.

13. The system recited in claim 9, where said wireless signal uses radio frequency technology.

14. The system recited in claim 9, wherein said wireless signal uses optical light technology.

15. An system for monitoring and alerting an owner of the cell phone that said cell phone has exceeded a given distance between said owner and said cell phone comprising:
an accessory having a receiving and a transmitting means which monitors a first signal sent from a cell phone, said accessory associated with said owner;
a typical cell phone programmed to transmit said first signal to said accessory,
said accessory programmed to receive said first signal;
said accessory sending a second signal to said cell phone in response to receiving said first signal, and receive back from to said accessory,
said cell phone programmed to initiate an alerting means when said accessory is a specified distance from said cell phone.

16. The system recited in claim 17, wherein said accessory is programmed to initiate an alerting means when said accessory is a specified distance from said cell phone.

17. The system recited in claim 17, further comprising that said signal includes a unique identifier that said cell phone recognizes.

18. The system recited in claim 17, wherein said accessory is a pendant.

19. The system recited in claim 17, wherein said accessory is a part of a key chain.

20. The system recited in claim 17, wherein said accessory comprises a slim card design.

21. The system recited in claim 17, where said wireless signal uses radio frequency technology.

22. The system recited in claim 17, wherein said wireless signal uses optical light technology.

23. An system for monitoring and alerting an owner of the cell phone that said cell phone has exceeded a given distance between said owner and said cell phone comprising:
an accessory having a receiving and a transmitting means which sends a first signal to said cell phone and then monitors a second signal from a cell phone, said accessory associated with said owner;
a typical cell phone programmed to receive said first signal and transmit a second signal to said accessory in response to receive said first signal;
said accessory programmed to initiate an alerting means when said cell phone is a given distance from said accessory.

24. The system recited in claim 26, wherein said cell phone is programmed to initiate an alerting means when said accessory is a specified distance from said cell phone.

25. The system recited in claim 26, further comprising that said signal includes a unique identifier that said cell phone recognizes.

26. The system recited in claim 26, further comprising that said signal includes a unique identifier that said cell phone recognizes.

27. The system recited in claim 26, wherein said accessory is a pendant.

28. The system recited in claim 26, wherein said accessory is a part of a key chain.

29. The system recited in claim 26, wherein said accessory comprises a slim card design.

30. The system recited in claim 26, where said wireless signal uses radio frequency technology.

31. The system recited in claim 26, wherein said wireless signal uses optical light technology.
